(19) United States
(12) Patent Application Publication
(10) Pub. No.: US 2011/0298349 A1
(43) Pub. Date: Dec. 8, 2011

(54) FURNITURE HINGE

(76) Inventor: Harald SUTTERLÜTTI, Fussach (AT)

(21) Appl. No.: 13/215,504

(22) Filed: Aug. 23, 2011

Related U.S. Application Data
(63) Continuation of application No. PCT/AT2010/000080, filed on Mar. 17, 2010.

(30) Foreign Application Priority Data
Mar. 25, 2009 (AT) A 477/2009

(51) Int. Cl. E05D 11/10; A47B 96/00; E05F 3/20

(52) U.S. Cl. 312/326; 16/352

(57) ABSTRACT

A furniture hinge, comprising a fitting part and a hinge cup that is pivotably connected thereto by way of at least one articulated lever, the articulated lever being connected to the hinge cup by way of an articulated axis (A), and further comprising a cushioning apparatus which can be actuated by an actuating element and is provided to cushion a relative movement between the fitting part and the hinge cup, the actuating element being mounted inside the hinge cup rotatably about a rotational axis (S) extending substantially parallel to the articulated axis (A) of the hinge cup, and the cushioning apparatus comprising at least one linear cushioning member having at least one linearly displaceable plunger, said member being disposed on the outside of the hinge cup, characterized in that a transmission mechanism is provided, which converts a rotary movement of the actuating element into a linear movement of the plunger of the linear cushioning member, and the hinge cup and the linear cushioning member or members disposed on the hinge cup are all disposed inside a cylindrical bore (B) in the furniture part in the installed position.

The present invention concerns a furniture hinge comprising a fitment portion and a hinge cup pivotably connected thereto by way of at least one hinge lever, wherein the hinge lever is connected to the hinge cup by way of a hinge axis, and a damping device actuable by an actuating element for damping a relative movement between the fitment portion and the hinge cup, wherein the actuating element is mounted within the hinge cup rotatably about an axis of rotation extending substantially parallel to the hinge axis of the hinge cup and the damping device has at least one linear damper which is arranged at the outside of the hinge cup and has at least one linearly displaceable piston.

The invention further concerns an article of furniture having a movable furniture part mounted movably by way of at least one furniture hinge of the kind to be described.

The damping action of a linear damper is essentially based on the flow resistance of a damping fluid in a fluid chamber. Damping devices having a piston with a linear damping stroke usually have a travel-dependent damping function, that is to say the degree of damping is dependent on the available damping stroke of the piston. Thus a sufficient damping travel is accordingly to be provided to achieve the desired soft damping of a relative movement between the fitment portions. A particular requirement is therefore that of arranging the damping device in as space-saving a fashion as possible and inconspicuously on the hinge cup, but at the same time also ensuring an adequate damping stroke and thus a satisfactory damping action in respect of the furniture hinge.

A furniture hinge having a hinge cup and a linear damper arranged at the outside of the hinge cup is known for example from WO 2008/104009 A1 to the present applicant. The linear damper in that case can have a linearly displaceable piston, the direction of the linear movement of the piston being oriented substantially parallel to a hinge axis of the hinge.

WO 2007/038815 A1 to the present applicant also shows in FIGS. 32 through 37 a furniture hinge having a linear damper which can be acted upon by way of an actuating element mounted in the hinge cup. In that case the linear damper is concealed under a cover housing which is fitted onto the hinge cup.

Therefore the object of the present invention is to propose a furniture hinge of the general kind mentioned in the opening part of this specification, wherein the damping device can be arranged on the hinge cup in an efficient and inconspicuous fashion.

According to the invention that is achieved by the features of claim 1. Further advantageous configurations of the invention are recited in the appendant claims.

According to the invention it is therefore provided that there is provided a transmission mechanism which converts a rotary movement of the actuating element into a linear movement of the piston of the linear damper and the hinge cup and the linear damper or dampers arranged on the hinge cup are arranged in the installation position all within a cylindrical bore in the furniture part.

The pivotally mounted actuating element can be caused to perform a rotary movement as from a predetermined relative position of the fitment portions with respect to each other, wherein the actuating element can be acted upon by a hinge lever of the hinge and/or the carcass-side fitment portion (for example the hinge arm). The transmission mechanism provided can convert that rotary movement of the actuating element into a linear movement of the piston. The transmission mechanism provided can therefore transform a relatively slight rotary movement of the actuating element into an increased linear movement of the piston. In that way it is possible to achieve an enhanced damping travel and consequently also an enhanced damping action on the part of the linear damper, whereby it is possible to provide for efficient movement damping of the movable furniture part. In that case the damping range of the movable furniture part can begin to act as from an angular position of greater than or equal to 35° in relation to the complete end position.

In a possible embodiment it can be provided that the hinge cup has at least one laterally projecting fixing flange, wherein the damping device is arranged beneath the fixing flange and at the outside of the hinge cup. In that way on the one hand it is possible to provide for a very compact installation of the damping device, while on the other hand the damping device does not appear at all externally in the case of a hinge cup when fitted into a standard bore. The damping device can therefore be arranged as a whole structural unit beneath the plane formed by the opening of the hinge cup.

In a preferred embodiment of the invention it can be provided that the direction of the linear movement of the piston extends transversely, preferably substantially at a right angle, to the hinge axis at the hinge cup side. In that case the linear movement of the piston or pistons can be substantially horizontally, that is to say substantially parallel to a support surface of the fixing flange which in the mounted position bears against a surface of the movable furniture part.

A particular advantage is afforded in that the hinge cup together with a housing of the damping device, that at least partially encloses the hinge cup, can be received as a common structural unit in a bore of predetermined nominal diameter, wherein the fixing flange in the mounted position substantially completely covers the housing of the damping device. In that case the housing of the damping device is disposed externally on the hinge cup, that is to say outside the internal cavity in the hinge cup, in which at least one hinge lever of the furniture hinge is immersed in the closing movement. The actuating element of the damping device can be mounted movably within the hinge cup or can extend into the internal cavity in the hinge cup so that it can be actuated by the hinge lever and/or by a fitment portion as from a predetermined angular position of the furniture hinge. In that arrangement the actuating element is mounted on the hinge cup rotatably about a horizontal axis. The rotary angle range of the actuating element in that case is between 70° and 170°, preferably between 130° and 160°.

In a preferred embodiment the piston of the linear damper is guided displaceably in a fluid chamber. The fluid chamber can in that case be in the form of a cavity in a housing of the damping device or alternatively it can be formed by a cavity in a cylinder in which the piston is linearly displaceably guided. The linear damper is desirably in the form of a fluid damper filled with a liquid or gaseous damping medium.

In a desirable configuration the actuating element is operatively connected to the piston of the linear damper at least in the damping stroke of the damping device. In that way the piston of the linear damper can be motionally coupled to the actuating element so that, upon a rotary movement of the actuating element, the piston of the linear damper is also moved therewith, that is to say it is displaced linearly within the fluid chamber. It can also be provided that the actuating element is motionally coupled constantly to the piston of the linear damper by way of the transmission mechanism. The continuous coupling between the actuating element and the piston of the linear damper can provide that force is applied directly to the linear damper in the damping stroke, whereas in the return stroke the actuating element can be moved back again into a position for the next damping stroke, by a return mechanism associated with the linear damper. In that way a specific return mechanism for the actuating element is not necessarily required.

In a preferred embodiment of the invention it can be provided that a side wall of the hinge cup has an opening, wherein the transmission mechanism extends from the inside of the hinge cup through the opening to the outside of the hinge cup. In that respect it may be desirable if the transmission mechanism has at least one lever which is hingedly connected to the actuating element and which is connected (also hingedly) to the piston of the linear damper or can be coupled thereto at least at times. In the damping stroke the lever is operatively connected on the one hand to the actuating element, and on the other hand it is operatively connected by way of a piston rod associated with the piston of the linear damper. It can also be provided that the piston rod is of a cranked shape, wherein the piston rod extends through the opening from the inside of the hinge cup to the outside thereof, by virtue of the cranked shape. In the configuration just described the transmission mechanism includes the lever and the piston rod of the linear damper. The piston and the piston rod can in that case also be of an integral configuration—for example in the form of integral injection molding of plastic material.

In a possible embodiment of the invention the outside of the hinge cup has at least one flat face which makes it possible to mount the damping device. In a development of the invention it can be provided that the hinge cup has oppositely disposed side walls, wherein the side walls at the outside thereof each have a respective flat surface provided for the arrangement of separate damping devices. In a preferred embodiment of the invention it can be provided that the hinge cup at the outside thereof has a respective damping device, wherein the hinge cup together with the damping devices arranged thereon can be jointly inserted within a standard bore provided on a furniture part and is arranged within a notional bore diameter of the standard bore.

To provide an additional damping force each damping device can have a first and a second fluid chamber which are filled with damping fluid and which are connected together by a passage. In this connection it may be desirable if a piston can immerse into the first fluid chamber, the volume of the first fluid chamber being changeable by the piston. A device can be arranged in the second fluid chamber, which is deformable or movable by a flow of damping fluid into or out of the second fluid chamber, to change the volume of the second fluid chamber. The said device can have either a deformable compressible material portion arranged in the second fluid chamber or alternatively a piston displaceable in the second fluid chamber.

The two fluid chambers are therefore connected in serial relationship and are in fluid-conducting communication by way of said at least one passage. The damping fluid of the first fluid chamber, that is displaced by the first piston during the damping stroke, also flows through the passage into the second fluid chamber—apart from a possible residual compressibility of the damping fluid—, wherein the volume of the second fluid chamber can be changed by the fluid pressure. The second fluid chamber thus forms a compensating space for the displaced damping fluid, that is variable during compression or decompression. The second fluid chamber can be arranged in a very compact structure relative to the first fluid chamber, whereby it is possible to achieve particularly small constructions for the damping device. In principle the passage connecting the two fluid chambers can also be of a very short length (for example in the form of a hole in the function of an overflow opening). It is preferably provided that the passage connecting the two fluid chambers extends from the bottom region of the first fluid chamber to the inlet region of the second fluid chamber.

Further details and advantages of the present invention are described by means of the specific description hereinafter. In the drawings:

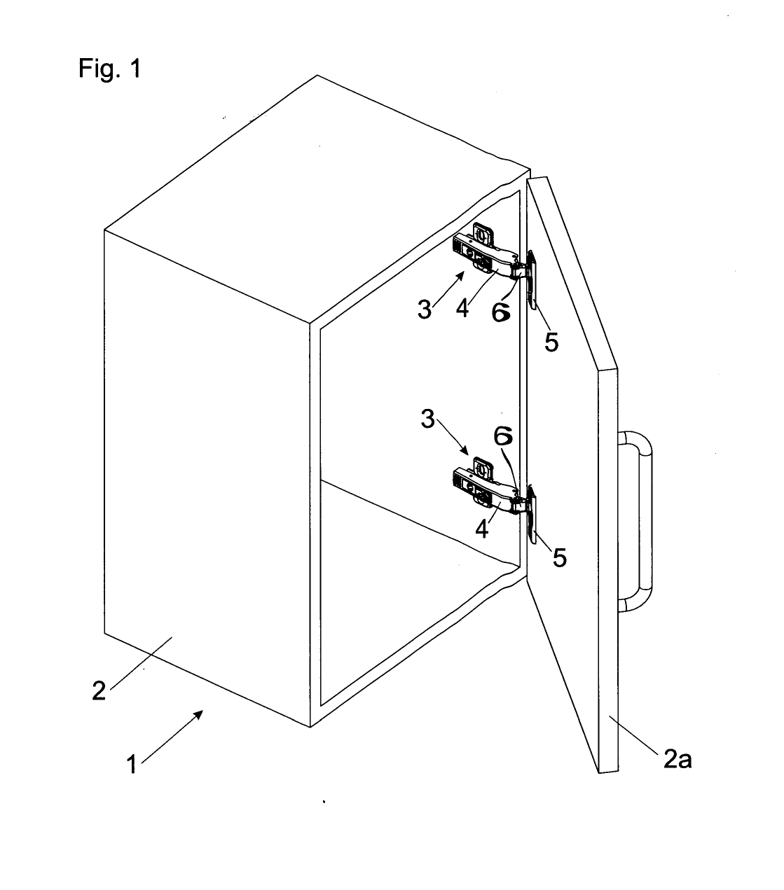

FIG. 1 shows a perspective view of an article of furniture having a movable furniture part pivotably mounted to the furniture carcass by way of furniture hinges according to the invention,

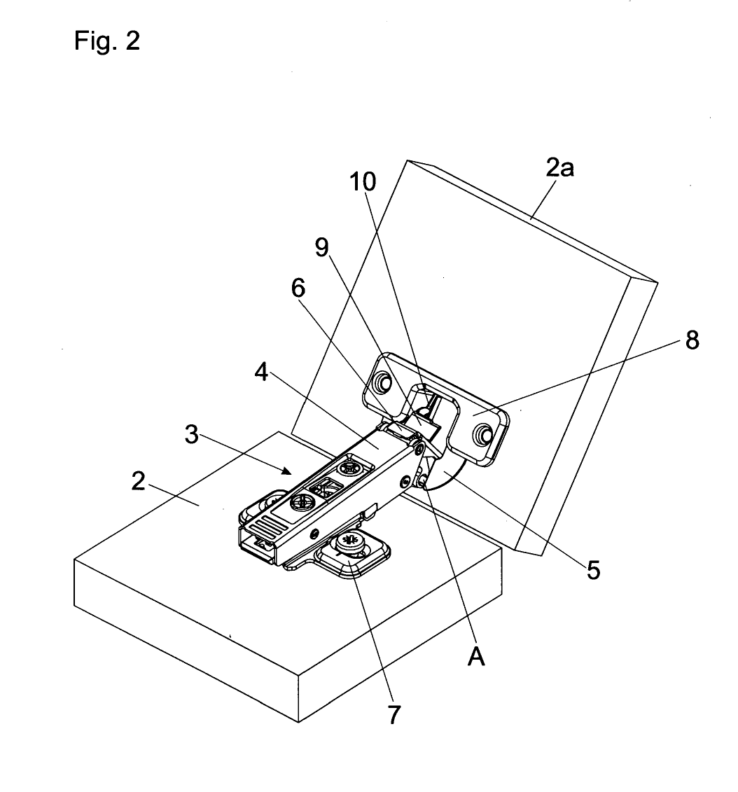

FIG. 2 shows a perspective view of the furniture hinge in an open position,

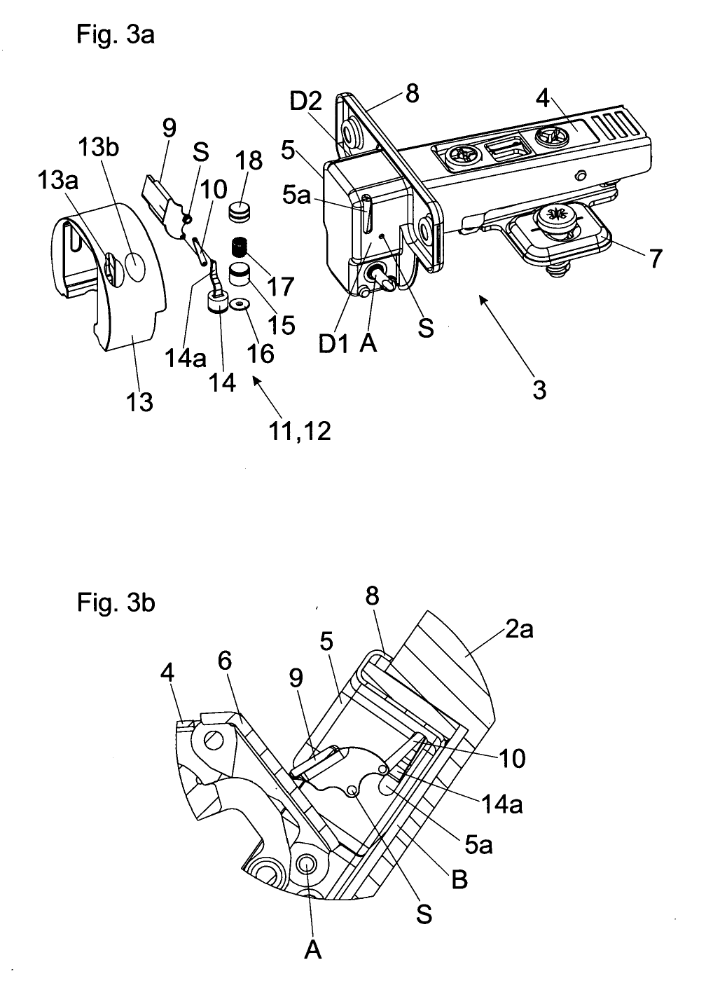

FIGS. 3a, 3b show a perspective view and a sectional view of the hinge cup in the exploded condition of the furniture hinge,

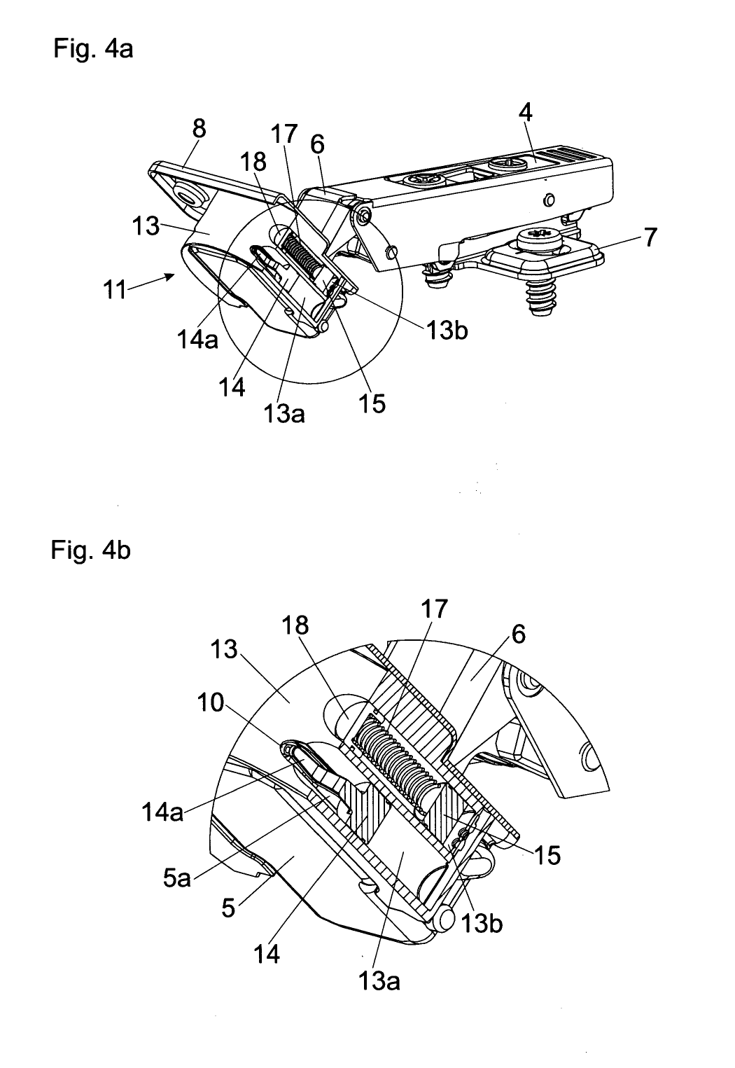

FIGS. 4a, 4b show a partly sectional view and an enlarged detail view thereof the furniture hinge with a damping device arranged at the outside,

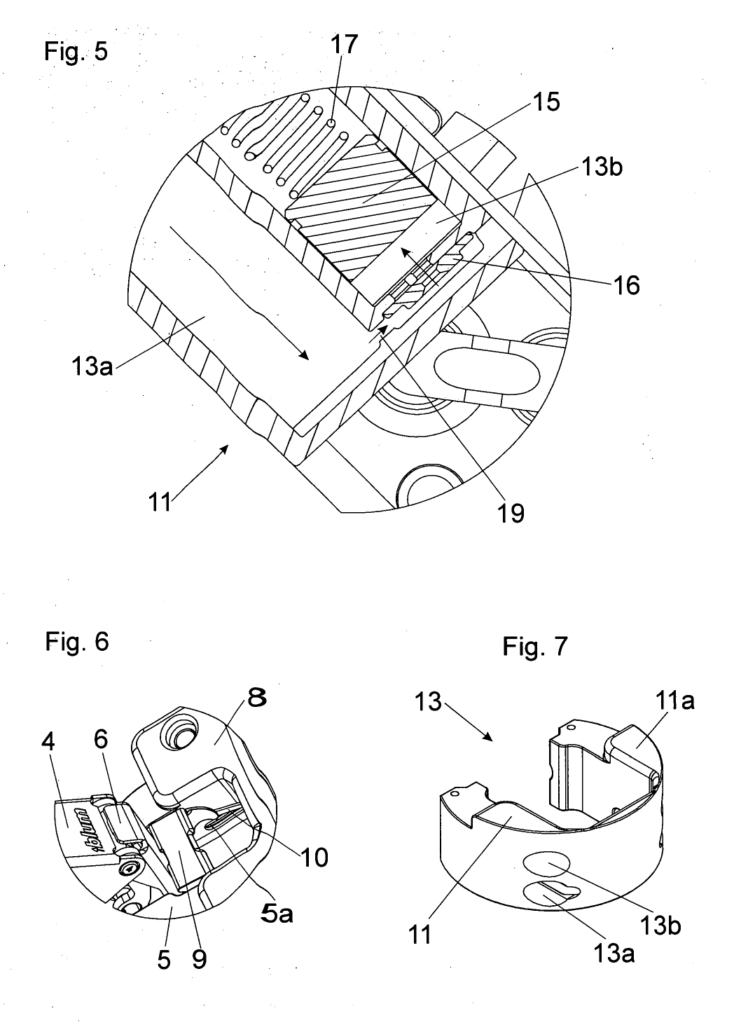

FIG. 5 shows a sectional view of a damping device with two fluid chambers connected together by a passage,

FIG. 6 shows a perspective view from above of the hinge cup with an actuating element of the damping device, that is mounted therein,

FIG. 7 shows a possible embodiment of a housing of the damping device, which can be sunk together with the hinge cup in a circular bore of the movable furniture part,

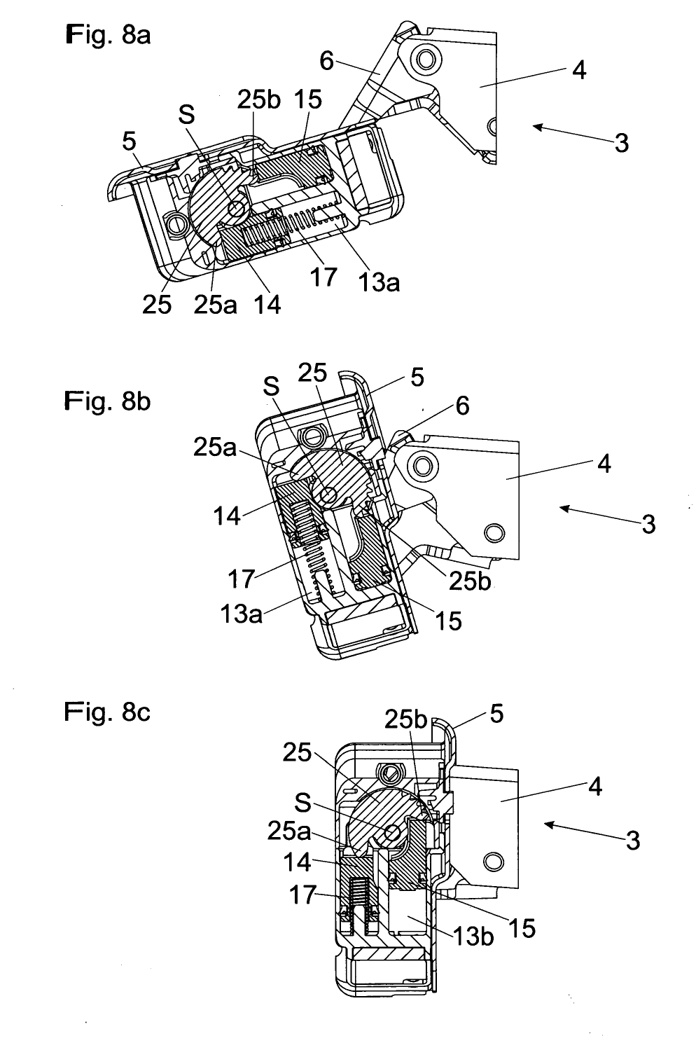

FIGS. 8a-8c show a further embodiment of the invention, wherein the transmission mechanism has a rotatably mounted lever by which at least one piston of the damping device is movable, and

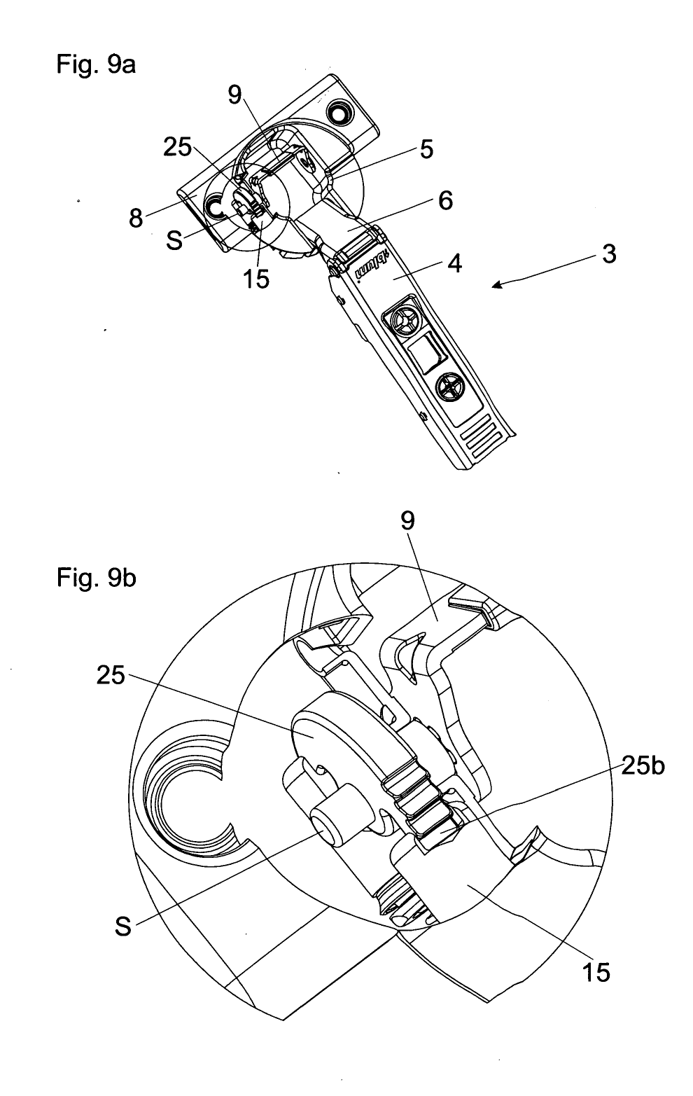

FIGS. 9a, 9b show a perspective view and an enlarged detail view thereof of the furniture hinge with the transmission mechanism as shown in FIGS. 8a-8c.

FIG. 1 shows a perspective view of an article of furniture 1 with a furniture carcass 2, wherein a movable furniture part 2a is pivotably mounted to the furniture carcass 2 by way of furniture hinges 3 according to the invention. The illustrated furniture hinges 3 each include a carcass fitment portion 4 in the form of a hinge arm and a hinge cup 5 sunk in a bore in the movable furniture part 2a. The hinge cup 5 is connected to the carcass fitment portion 4 pivotably by way of at least one hinge lever 6. The furniture hinge 3 includes a damping device (not visible here) whereby the movement of the movable furniture part 2a can be damped towards the end of the closing movement and/or towards the end of the opening movement until the complete end position is reached.

FIG. 2 shows the furniture hinge 3 in an open position. Fixed to the furniture carcass 2 is a base plate 7 which can be releasably latched to the fitment portion 4 in the form of the hinge arm. The hinge cup 5 is sunk in a standard bore provided in the movable furniture part 2a and has a fixing flange 8, by which the hinge cup 5 can be fixed to the movable furniture part 2a. It is possible to see an actuating element 9 which is mounted in the internal cavity in the hinge cup 5 rotatably about an axis extending substantially parallel to a hinge axis (A) of the furniture hinge 3. Towards the end of the closing movement of the furniture hinge 3 the rotatably mounted actuating element 9 is acted upon by the outer hinge lever 6 and caused to rotate thereby. It is also possible to see a lever 10 which is hingedly connected to the actuating element 9 and which forms a part of the transmission mechanism and which is provided to convert a rotary movement of the actuating element 9 into a linear piston movement of the linear damper (not visible here).

FIG. 3a shows an exploded perspective view of the furniture hinge 3. The fitment portion 4 in the form of the hinge arm can be snapped onto the base plate 7. The hinge cup 5 has a fixing flange 8 for fixing to the movable furniture part 2a, wherein the damping device 11 is mounted in the mounted position at the outside of the hinge cup 5 and beneath the fixing flange 8. The damping device 11 is in the form of a linear damper 12 having a housing 13. The housing 13 which is in the shape of a circular arc has a first fluid chamber 13a in which a first piston 14 having a piston rod 14a is linearly displaceable. The piston rod 14a is of a cranked shape so that in the mounted position the piston rod 14a is disposed at least partially within an opening 5a associated with the hinge cup 5. The end of the piston rod 14a, remote from the piston 14, is hingedly connected to a lever 10 to be arranged in the internal cavity in the hinge cup 5. The other end of the lever 10 is hingedly connected to the rotatable actuating element 9. The actuating element 9 is supported rotatably about an axis of rotation (S) within the hinge cup 5, wherein that axis of rotation (S) can also be seen on the hinge cup 5. In the illustrated embodiment therefore the transmission mechanism is formed by the lever 10 and the piston rod 14a hingedly connected thereto. When the actuating element 9 is acted upon by the hinge lever 6 (FIG. 2) the actuating element 9 is rotated relative to the hinge cup 5, in which case that rotary movement is transmitted by way of the lever 10 and the piston rod 14a to the piston 14 which is then displaced within the first fluid chamber 13a. In addition the housing 13 has a second fluid chamber 13b in which a second piston 15 is linearly displaceable in a direction in opposite relationship to the first piston 14. The first fluid chamber 13a and the second fluid chamber 13b are in fluid-conducting communication with each other by way of a passage (not visible here) so that, in the damping stroke, the damping medium can pass from the first fluid chamber 13a by way of the passage and by way of a switching blade 16 having at least one through-flow opening into the second fluid chamber 13b so that the second piston 15 is urged upwardly within the second fluid chamber 13b against the force of the return spring 17. After the damping stroke has been performed the second piston 15 is urged back again by the force of the return spring 17, whereupon the damping medium passes into the first fluid chamber 13a again by way of the passage and thereby moves the first piston 14 into the starting position again.

By virtue of that return movement of the first piston 14, because of the permanent coupling (piston rod 14a and lever 10), the actuating element 9 is also moved back again into a starting position for the next damping stroke. In that way it is sufficient if both the two pistons 14, 15 and also the actuating element 9 can be moved again back into the starting position for the next damping stroke by way of the provided return spring 17. It should be noted that the two pistons 14, 15 each terminate in sealing relationship with the inside wall of the two fluid chambers 13a, 13b so that the damping medium is disposed exclusively between the two pistons 14, 15. A sealing element 18 forms the upper termination of the second fluid chamber 13b. The linear movement of the two pistons 14, 15 extends substantially perpendicularly to a hinge axis (A) of the furniture hinge 3. At the outside of mutually opposite side walls the hinge cup 5 has flat surfaces D1 and D2 for arranging the damping device 11. In plan view therefore the hinge cup 5 is at least approximately of a rectangular configuration.

FIG. 3b shows a sectional view of the hinge cup 5 which is sunk in a bore (B) in the movable furniture part 2a. The hinge lever 6 connecting the carcass fitment portion 4 and the hinge cup 5 is mounted to the hinge cup 5 at a hinge axis A. The actuating element 9 mounted rotatably about the axis of rotation (S) is arranged pivotably at the inside of the internal cavity in the hinge cup 5. The lever 10 is hingedly connected to the actuating element 9. It is possible to see the piston rod 14a which is hingedly connected to the lever 10 by way of the opening 5a in the hinge cup 5. FIG. 3b shows the beginning of the damping process, wherein the hinge lever 6 is acting on the actuating element 9 and then pivots it in the clockwise direction. That movement is transmitted by way of the lever 10, in which case the piston rod 14a (and therewith the piston 14) is also moved so that the first piston 14 is displaced against the fluid pressure in the first fluid chamber 13a.

FIG. 4a shows a partly sectional view of the furniture hinge 3, wherein the damping device 11 in the installed position is mounted at the outside of the hinge cup 5 and is completely covered by the fixing flange 8. The housing 13 of the damping device 11 has a circular peripheral surface so that the hinge cup 5 together with the surrounding housing 13 of the damping device 11 is accommodated within the provided bore (B) (FIG. 3b) of a predetermined nominal diameter (for example 35 mm) of the movable furniture part 2a. FIG. 4b shows a view on an enlarged scale of the region circled in FIG. 4a. It is possible to see the hinge cup 5 with the opening 5a provided therein, the Figure also showing the hinged connection between the lever 10 and the piston rod 14a of the piston 14. When the actuating element 9 which is not visible here is acted upon by the hinge lever 6 the piston 14 is pushed into the first fluid chamber 13a by way of the lever 10 and the piston rod 14a. The first fluid chamber 13a is in fluid-conducting communication with the second fluid chamber 13b so that the damping medium which is displaced in the course of the damping stroke, of the first fluid chamber 13a, passes into the second fluid chamber 13b and thus urges the second piston 15 upwardly against the force of the return spring 17.

FIG. 5 shows a sectional view of a damping device 11 having the first fluid chamber 13a in which the first piston 14 (not visible here) is linearly displaceably guided. The illustrated Figure represents the position of the second piston 15 at the beginning of the damping stroke, the second piston 15 being linearly displaceably guided in the second fluid chamber 13b. The direction of movement of the first piston 14 is substantially parallel to that of the second piston 15 and in the opposite direction. The illustrated arrows clearly show the flow direction of the damping fluid during the damping stroke. In the damping stroke the damping medium is pressed from the first fluid chamber 13a by way of a passage 19 and by way of a switching blade 16 provided with at least one through-flow opening into the second fluid chamber 13b, whereupon the second piston 15 is displaced rearwardly against the force of the return spring 17. After the damping stroke the return spring 17 can move the second piston 15 in the opposite direction again so that the damping medium passes back again into the first fluid chamber 13a in the opposite direction to the indicated arrows and thereby urges the first piston 14 (and therewith the motionally coupled actuating element 9) into the starting position again for the next damping stroke. Instead of the second piston 15 it is also possible to arrange a device in the second fluid chamber 13b, which is deformable or movable to change the volume of the second fluid chamber 13b. For example therefore instead of the second piston 15 it is possible to use a compressible material portion (for example a TPU portion or foam rubber) which is compressible during the damping stroke. In such a configuration the return spring 17 is to be arranged in the first fluid chamber 13a, in which case in the return stroke of the return spring 17 the damping fluid is drawn by reduced pressure again from the second fluid chamber 13b into the first fluid chamber 13a.

FIG. 6 shows a perspective view from above of the hinge cup 5, the damping device 11 (not visible here) being arranged in the mounted position beneath the fixing flange 8 and at the outside of the hinge cup 5. The Figure clearly shows the rotatable actuating element 9 which can be acted upon by the hinge lever 6 towards the end of the closing movement of the furniture hinge 3. The resulting rotation of the actuating element 9 also pulls the lever 10 towards the left, wherein the piston rod 14a of the piston 14, that is hingedly connected to the lever 10, is also displaceable within the slot-shaped opening 5a in the hinge cup 5. The hinge lever 6 is not connected to the actuating element 9, the actuating element 9 of the damping device 11 is first acted upon as from a predetermined relative position of the hinge cup 5 with respect to the fitment portion 4 and is then urged into the hinge cup 5, wherein that movement of the actuating element 8 (and therewith the closing movement of the furniture hinge 3) can also be damped by the damping device 11.

FIG. 7 shows a perspective view of the housing 13 which is adapted to receive two oppositely disposed damping devices 11 and 11a. The damping devices 11 and 11a can each be identical so that a total of four pistons—which are displaceable in four different fluid chambers—are available for damping a hinge movement. The Figure diagrammatically indicates the two fluid chambers 13a and 13b which obviously are to be closed by suitable sealing elements so that the damping fluid arranged in the two fluid chambers 13a and 13b cannot escape. The housing 13 has a circular outside peripheral surface so that it can be sunk in a standard bore (B) provided in the movable furniture part. The housing 13 together with the damping devices 11 arranged therein is thus so disposed that the housing 13 is supported beneath the fixing flange 8 and thus does not project beyond the remaining components of the furniture hinge 3. In the illustrated embodiment the housing 13 which embraces the hinge cup 5 in a clip-like configuration is in one piece with the damping devices 11, 11a. It will be appreciated that it is also possible for the two damping devices 11 and 11a to be respectively disposed in a separate housing, which housings can then be arranged as separate units at the flat surfaces D1 and D2 identified in FIG. 3a.

FIGS. 8a-8c show a somewhat modified embodiment of the transmission mechanism for converting a rotary movement of the actuating element 9 into a linear movement of the piston 14, wherein the transmission mechanism has a lever 25 mounted pivotally about the axis of rotation (S) instead of the previously illustrated lever 10 and the piston rod 14. The axis of rotation (S) is arranged coaxially with the axis of rotation of the actuating element 9 mounted in the interior of the hinge cup 5, wherein the actuating element 9 and the pivotable lever 25 can be mounted on a common shaft and are non-rotatably connected together. In a movement of the actuating element 9 therefore the lever 25 is also rotated about the axis of rotation (S). The lever 25 is mounted outside the hinge cup 5 and can be mounted in the housing 13 shown in FIG. 7. The lever 25 serves to act on at least one piston 14, in the illustrated embodiment however it serves to control the linear movement of two pistons 14, 15. The lever 25 rotatable about the axis of rotation (S) has two lever arms 25a, 25b which respectively bear loosely against the two displaceable pistons 14 and 15. The lever 25 can possibly also be connected—in particular hingedly—to the two pistons 14, 15, which connection can also be made by way of an additional lever and/or by way of a piston rod. FIG. 8a shows the open position of the furniture hinge 3. In the closing movement of the furniture hinge 3 the hinge lever 6 encounters the actuating element 9 mounted rotatably in the hinge cup 5 (FIGS. 3b and 8b), in which case, in the further closing movement of the hinge 3, the lever 25 is also rotated in the counter-clockwise direction. The piston 14 is urged into the first fluid chamber 13a by the lever arm 25a of the lever 25, wherein the second piston 15 is also displaced in the opposite direction within the second fluid chamber 13b through the passage 19 (not visible here; see FIG. 5) (FIG. 8c). After the damping stroke has taken place the return spring 17 urges the first piston 14 in the fluid chamber 13a back into the starting position again, in which case the lever 25 is also rotated back in the clockwise direction by the pressure on the lever arm 25a. Due to that return movement the second piston 13b in the fluid chamber 13b is also moved back into the starting position, that is to say it is pushed into the fluid chamber 13b, and at the same time the actuating element 9 coupled to the lever 25 is also returned within the hinge cup 5 into a readiness position for the next damping stroke.

FIG. 9a shows a perspective and partly broken-away view from above of the furniture hinge 3. The fitment portion 4 in the form of the hinge arm is hingedly connected to the hinge cup 5 by way of at least one hinge lever 6. It is possible to see the actuating element 6 which is pivotable about the axis of rotation (S) and which can be caused to perform a pivotal movement towards the end of the closing movement of the hinge 3 by the hinge lever 6. Mounted at the outside of the hinge cup 5 is the lever 25 which is motionally coupled to the actuating element 9 so that in a rotary movement of the actuating element 9 the lever 25 is also moved. The movement of at least one piston 15 of the linear damper can be caused to occur by the lever 25. The hinge cup 5 and the linear damper or dampers 12 arranged on the hinge cup 5 are all arranged in the installation position within a cylindrical bore (B) in the furniture part 2a (see FIG. 3b).

FIG. 9b shows a view on an enlarged scale of the broken-away detail of FIG. 9a. The actuating element 9 mounted in the hinge cup 5 and the lever 25 mounted at the outside of the hinge cup 5 are mounted rotatably about a common axis of rotation (S). The lever 25b has a lever arm 25b which bears against the upper piston 15 and which can be returned again to a starting position for the next damping stroke after a damping stroke has been effected (due to the force of the return spring 17 shown in FIGS. 8a-8c). The lever 25 further has a second lever arm 25a by which the lower piston 14 can be urged into the fluid chamber 13a in the damping stroke (FIGS. 8a-8c).

The present invention is not limited to the illustrated embodiments but includes or extends to all variants and technical equivalents which can fall within the scope of the appended claims. The positional references adopted in the description such as for example up, down, lateral and so forth are also related to the directly described and illustrated Figure and are to be appropriately transferred to the new position upon a change in position.

1. A furniture hinge, comprising:
a fitment portion,
a hinge cup pivotally connected to said fitment portion by way of at least one hinge lever, said hinge lever is connected to said hinge cup by way of a hinge axis,
a damping device actuable by an actuating element for damping a relative movement between said fitment portion and said hinge cup, said actuating element is mounted within said hinge cup rotatably about an axis of rotation extending substantially parallel to said hinge axis of said hinge cup,
said damping device has at least one linear damper which is arranged at the outside of said hinge cup, said damping device has at least one linearly displaceable piston,
a transmission mechanism which converts a rotary movement of said actuating element into a linear movement of said piston of said linear damper,
wherein said hinge cup and said linear damper or dampers arranged on said hinge cup are arranged in the installation position all within a cylindrical bore in a furniture part.

2. The furniture hinge according to claim 1, wherein the hinge cup has at least one laterally projecting fixing flange, wherein the damping device is arranged beneath the fixing flange and at the outside of the hinge cup.

3. The furniture hinge according to claim 1, wherein the piston of the linear damper is guided displaceably in a fluid chamber.

4. The furniture hinge according to claim 1, wherein the direction of the linear movement of the piston is substantially perpendicularly to the hinge axis of the furniture hinge.

5. The furniture hinge according to claim 1, wherein the linear damper is in the form of a fluid damper.

6. The furniture hinge according to claim 1, wherein the actuating element can be acted upon during a hinge movement by the fitment portion or by the hinge lever of the furniture hinge.

7. The furniture hinge according to claim 1, wherein at least in the damping stroke of the damping device the actuating element is operatively connected to the piston of the linear damper.

8. The furniture hinge according to claim 1, wherein the actuating element is motionally coupled continuously to the piston of the linear damper by way of the transmission mechanism.

9. The furniture hinge according to claim 1, wherein a side wall of the hinge cup has an opening, wherein the transmission mechanism extends from the inside of the hinge cup through the opening to the outside of the hinge cup.

10. The furniture hinge according to claim 1, wherein the transmission mechanism has at least one lever which is hingedly connected to the actuating element and which is connected or can be coupled to the piston of the linear damper.

11. The furniture hinge according to claim 10, wherein the lever is connected or can be coupled to a piston rod of the piston, the piston rod being part of the transmission mechanism.

12. The furniture hinge according to claim 11, wherein the piston rod is of a cranked shape, wherein by virtue of the cranked shape the piston rod extends through an opening of the hinge cup from the inside of the hinge cup to the outside thereof.

13. The furniture hinge according to claim 1, wherein the piston of the linear damper has a piston rod, wherein the piston and the piston rod are of a one-piece construction.

14. The furniture hinge according to claim 1, wherein the outside of the hinge cup has at least one flat surface at which the damping device is arranged.

15. The furniture hinge according to claim 1, wherein the hinge cup has oppositely disposed side walls, wherein the side walls at their outside each have a respective flat surface provided for the arrangement of separate damping devices.

16. The furniture hinge according to claim 1, wherein at its outside the hinge cup has a respective damping device, wherein the hinge cup together with the damping devices arranged thereon can be inserted jointly within the provided bore and is arranged within a notional bore diameter of the bore.

17. The furniture hinge according to claim 1, wherein the damping device has first and second fluid chambers filled with damping fluid and connected together by a passage.

18. The furniture hinge according to claim 17, wherein a piston is immersed in the first fluid chamber, by which piston the volume of the first fluid chamber can be changed, and wherein arranged in the second fluid chamber is a device which is deformable or movable by a flow of damping fluid into or out of the second fluid chamber, to change the volume of the second fluid chamber.

19. The furniture hinge according to claim 18, wherein the device has a deformable material portion arranged in the second fluid chamber or a piston displaceable in the second fluid chamber.

20. The furniture hinge according to claim 1, wherein the damping device has a first piston and at least one second piston with a linear damping stroke, the direction of the linear damping stroke of the first piston extending substantially parallel relative to the linear damping stroke of the second piston.

21. The furniture hinge according to claim 1, wherein the transmission mechanism has at least one rotatably mounted lever which is motionally coupled to the pivotally mounted actuating element.

22. The furniture hinge according to claim 21, wherein at least one piston is movable by the lever.

23. The furniture hinge according to claim 21, wherein the lever is in the form of a double-armed lever, wherein a first lever arm cooperates with the first piston of the damping device and a second lever arm cooperates with a second piston of the damping device.

24. An article of furniture having at least one movable furniture part which is mounted movably by way of at least one furniture hinge according to claim 1.
